(19) United States
(12) Patent Application Publication
(10) Pub. No.: US 2009/0258109 A1
(43) Pub. Date: Oct. 15, 2009

(54) OPTIMIZED SUGAR-FREE HARD COATING PROCESS

(75) Inventors: Dominique ORTIZ DE ZARATE, Merville (FR); Guillaume RIBADEAU-DUMAS, Verlinghem (FR)

Correspondence Address: YOUNG & THOMPSON, 209 Madison Street, Suite 500, ALEXANDRIA, VA, 22314, US

(73) Assignee: ROQUETTE FRERES, Lestrem (FR)

(21) Appl. No.: 12/421,981

(22) Filed: Apr. 10, 2009

(30) Foreign Application Priority Data
Apr. 10, 2008 (FR) 08 01988

(51) Int. Cl. A23P 1/08; A23P 1/04; A23G 4/20; A23L 1/22

(52) U.S. Cl. 426/5; 426/304; 426/293; 426/103; 426/93; 426/48

(57) ABSTRACT

A novel process of hard coating, for creating a hard, crunchy coating on the surface of a product in less than two hours, includes a plurality of cycles each including: applying a coating syrup containing at least one polyol obtained by hydrogenation of disaccharides, and the coating syrup having 60%-90% solids content by weight and preferably 70%-85% by weight; drying by using air with a temperature of 40° C.-70° C., for a time of at least 1 minute and of not more than 5 minutes; the number of cycles being such that a degree of enlargement of greater than 25%, preferentially greater than 30% and more preferentially greater than 32% is obtained. One variant of the process according to the invention consists in adding, after applying the syrup, an amount of polyol powder of very high purity. The invention is also directed towards the coated products obtained by using the process.

### FIELD OF THE INVENTION

The present invention relates to a hard coating process. More specifically, the invention relates to a novel sugar-free hard coating process using one or more polyols that makes it possible to considerably reduce the manufacturing time while at the same time obtaining a quality product. The invention is also directed towards the coated products obtained by applying the process.

### TECHNICAL BACKGROUND

Hard coating is a unit operation employed in a great many fields and especially in confectionery and pharmaceutics. It may also concern the additives industry, namely flavourings, sweeteners, vitamins, enzymes, acids and plant-based products. This operation consists in creating a hard coating on the surface of solid or pulverulent products, in order to protect them for various reasons or to make them visually or gustatorily appealing.

Hard coating is directed towards obtaining a sweet, crunchy layer, which is always highly appreciated in the field of confectioneries, for instance chewing gums.

Coating of the core is performed in a drum that rotates about its axis, known as a coating pan, inside which is a plurality of cores forming a mass in motion, on the surface of which is distributed in liquid form the material constituting the future shell.

Hard coating always requires the use of a syrup containing crystallizable materials. The hard crystalline coating is obtained by applying this syrup and evaporating off the water thereby provided.

The term “hard coating” used in the present invention will also comprise the very similar techniques of smoothing and frosting. Smoothing consists of one or two applications or charges of a crystallizable syrup that is dilute when compared with the syrup used in hard coating. The aim is often to improve the surface appearance of coated products. Hard coating is often followed by smoothing. Frosting is likewise directed towards improving the appearance of the products, but also towards isolating these products from atmospheric moisture. This technique resembles hard coating, in the sense that a crystalline syrup is used. The essential difference lies in the fact that the number of coating cycles performed is only one, two or three.

Coating is a long and laborious process, involving a large number of successive steps. Each of these steps, also known as the coating cycle, typically includes a phase of applying, generally by spraying, a coating syrup (containing one or more polyols, but also occasionally binders such as gum arabic or gelatin, colorants such as TiO₂, intense sweeteners, etc.) on the cores, a rotating phase of distributing the said syrup over the cores, also known as the standing time, and a phase of drying each new layer of syrup, performed by blowing with hot, dry air. This succession of cycles must be performed a very large number of times, about 10 to 80 times, in order to obtain the desired degree of enlargement. In the present invention, the degree of enlargement, also known as the final degree of coating, is defined by the weight increase of the products. It is calculated by the ratio of the weight of the finished (coated) product to the weight of the centre or core before coating.

Sugar-free hard coating has been known for a long time and is described especially in patent EP 0 037 407, of which the Applicant is the proprietor, which concerns a process of coating with sorbitol. The coating is performed in successive cycles each comprising a first phase of adding sorbitol syrup with a richness of greater than 80% by dry weight to the bed of cores, a second phase (standing time) during which the addition is stopped, while maintaining the rotation of the drum, and a third phase during which the shell coating the cores is dried by blowing with hot, dry air, so as to evaporate off the water provided by the syrup and thus crystallize the applied polyol. This technique, although satisfactory in terms of quality of the finished product, remains long in practice, and may lead to problems of stickiness of the cores to each other during the standing time.

Another method directed towards improving the state of the art, and which especially enables the production of coated products of very good quality, with relatively short coating times, which are shorter than those of the processes known in the prior art, has been described in patent application EP 1 481 597, of which the Applicant is also the proprietor. This method makes it possible to obtain hard and crunchy coatings on the surface of a core, and includes at least one cycle that comprises a step of applying a coating syrup with a richness of greater than 80% (the richness being the content of polyol concerned relative to the dry matter content of the coating syrup) followed by a step of drying the cores, characterized in that the cycle does not comprise a standing time between the step of applying the coating syrup and the step of drying the cores.

In many coating processes, the coating syrup is liable to become tacky when it is applied to the cores and when it begins to dry. To reduce the stickiness phenomena, a polyol powder, also known as a bulking agent, may be applied after the phase of applying/spraying the coating syrup onto the cores, to accelerate the drying of the coating before it becomes too tacky. It should be noted that the polyol predominantly present in coating syrups may or may not be different in nature from the polyol mainly present in the bulking agent. On the other hand, using a bulking agent of different nature from that present in the coating syrup may lead to coating defects, such as failure to obtain a hard, crunchy layer. This is why this category of coating is generally likened to “soft” coating.

Patent application EP 0 625 311, of which the Applicant is the proprietor, describes a coating process likened to soft coating, but enabling the production of coated layers that are highly crystalline, hard and crunchy in the mouth. The process as described claims a succession of steps including the application of syrup composed, relative to its content of soluble solids, of at least 90% by weight of a polyol chosen from sorbitol, maltitol, xylitol, erythritol and isomalt, at least one step of applying a powder with a purity of greater than 95% by weight of this same polyol, and a step of distributing the syrup and the applied powder, characterized in that this cycle does not comprise a step of forced drying with a stream of air. As a result of omitting the forced drying step, the process is able to afford significant time saving.

With a desire to further improve the state of the art, and based on the wealth of observations listed above, the Applicant found that there was a need to develop a novel process of hard coating, advantageously using as sugar substitutes polyols that do not have the drawbacks described above and that combine all the following advantages:
that of being very quick and consequently of allowing considerable time savings and thus large productivity gains,
that of being simple to implement industrially,
that of being easily reproducible over time,
that of allowing the preparation of coated products of very high quality, which are not tacky and which do not significantly change in appearance or texture over time.

With a desire to further improve the state of the art, the Applicant thus set itself the aim of further reducing the manufacturing times while at the same time optimizing the quality of the finished products. After lengthy research studies, it has found that, surprisingly and unexpectedly, and contrary to what a person skilled in the art would have been accustomed to performing given the results described in the prior art, hard, crunchy sugar-free coatings can be obtained in a considerably reduced manufacturing time by combining the use of a coating syrup having a given solids content, and drying under certain conditions. Optionally, it is possible also to use a bulking agent. Advantageously, according to the invention, stickiness of the cores to each other, or their deformation under the effect of heat, as described previously in the prior art, is avoided.

Thus, the coating process in accordance with the invention is shortened relative to the processes described in the prior art, given the largely reduced total number of cycles, for a standard degree of enlargement, and without, however, having any impact on the physical or organoleptic qualities of the finished product.

### SUMMARY OF THE INVENTION

The present invention thus relates to a novel process of hard coating, which allows the creation of a hard, crunchy coating at the surface of a product in less than two hours, and comprising a plurality of cycles each comprising the following steps:
(a) a step of applying a coating syrup containing at least one polyol, the said polyol being obtained by hydrogenation of disaccharides, and the said coating syrup having a solids content of between 60% and 90% by weight and preferably between 70% and 85% by weight;
(b) a drying step comprising the use of air with a temperature of between 40° C. and 70° C., for a time of at least 1 minute and of not more than 5 minutes;
   the number of cycles being such that a degree of enlargement of greater than 25%, preferentially greater than 30% and more preferentially greater than 32% is obtained.

One variant of the process according to the invention consists in adding, after application of the coating syrup, a polyol powder of very high purity, preferably of greater than 95%.

The invention also relates to the products obtained by performing this novel coating process and/or one of its variants.

### DETAILED DESCRIPTION OF THE EMBODIMENTS

According to a general embodiment of the invention, the process comprises a succession of repetitive cycles always comprising a first step that consists in uniformly moistening the surface of the products in motion using the chosen coating syrup, a second step for uniformly distributing this syrup over the surface of the products (standing time), and finally a third step of drying by blowing with hot, dry air, which ensures evaporation of the water provided by the syrup and thus crystallization of the applied polyol.

According to one preferential embodiment, the coating cycle comprises two additional steps: a step of applying a polyol powder (typically by dusting) after applying the coating syrup and uniformly distributing it, this step being itself followed by a new step for uniformly distributing the powder (standing time), before arriving at the final step of drying by blowing with air.

In the present invention, the term “polyols” refers to the products obtained by catalytic hydrogenation of complex reducing sugars, disaccharides.

Consequently, the polyols concerned in the present invention are sugar-alcohols chosen from the group comprising maltitol, hydrogenated maltulose, hydrogenated isomaltulose, lactitol, α-D-glucopyranosyl-1-6-sorbitol (=1,6-GPS), α-D-glucopyranosyl-1-1-mannitol (=1,1-GPM) and α-D-glucopyranosyl-1-1-sorbitol (=1,1-GPS), and mixtures thereof.

In the present invention, hydrogenated isomaltulose is defined as any mixture of 1,1-GPM and of GPS (1,6-GPS and 1,1-GPS), irrespective of the ratio of each compound in the said mixture.

According to one particular mode of the invention, the polyols of the coating syrup contain a GPM-GPS mixture in a ratio of between 50/50 and 25/75.

These polyols are obtained industrially by hydrogenation of maltose, maltulose, isomaltulose or lactose.

The invention relates to a process of sugar-free hard coating, allowing the creation of a hard coating at the surface of a core in less than two hours, and comprising a plurality of cycles each comprising the following steps:
(a) a step of applying a coating syrup containing at least one polyol, the said polyol being obtained by hydrogenation of disaccharides, and the said coating syrup having a solids content of between 60% and 90% by weight and preferably between 70% and 85% by weight;
(b) a drying step comprising the use of air with a temperature of between 40° C. and 70° C., for a time of at least 1 minute and of not more than 5 minutes;
   the number of cycles being such that a degree of enlargement of greater than 25%, preferentially greater than 30% and more preferentially greater than 32% is obtained.

A coating syrup with a polyol richness of at least 80%, preferably at least 85%, more preferentially at least 90% and even more preferentially at least 92% by weight of solids will preferably be used.

The coating syrup may be prepared from any polyol sold by the Applicant in powder form under the brand names SweetPearl™ for maltitol and Isomaltisorb® for hydrogenated isomaltulose. Ready-to-use syrups, for instance maltitol syrups with high contents of maltitol, may also be used. The solids content of the coating syrup is between 60% and 90%, more preferably between 70% and 85% and even more preferentially greater than or equal to 76% and less than 80%.

The syrup used is brought to a temperature below 100° C. before application. In one advantageous embodiment, the temperature of the syrup is between 75° C. and 95° C. and even more advantageously between 85° C. and 93° C. It is applied, for example, by spraying.

The coating cycle according to the present invention comprises at least one drying step comprising the use of air at a temperature of between 40° C. and 70° C. and preferably between 45° C. and 55° C., for a time of at least 1 minute and of not more than 5 minutes.

According to one embodiment, step (b) comprises the use of air at a temperature of between 45° C. and 60° C. and preferably between 47° C. and 53° C.

According to one embodiment, the set of drying steps of the process that is the subject of the present invention comprises the use of air at least 45° C. and at not more than 55° C., for a cumulative time of at least 10 minutes and preferably at least 15 minutes.

According to one particularly advantageous mode of the present invention, the air temperature is 50° C. and the total cumulative blowing time of this air at 50° C. is 15 minutes.

Outside these “hot” phases, the temperature prevailing in the moving bed of cores to be coated is maintained throughout the majority of the coating process at a temperature of between 10° C. and 50° C. and preferably between 15 and 40° C.

It is also obvious that the drier the air blown into the turbine, the faster the process will be.

The desired degree of enlargement may be freely chosen as a function of the nature of the core to be coated or of the desired effects.

According to one particular embodiment of the present invention, degrees of enlargement of greater than 25% are obtained in less than 1 hour 30 minutes.

According to one embodiment, the polyol of step (a) is maltitol.

According to one preferential mode of the present invention, the cores to be coated are constituted of chewing gums, and the desired degrees of enlargement are between 20% and 50%, preferably between 30% and 45% and more preferentially between 30% and 40%.

According to another preferential mode of the invention, the cores to be coated are constituted of confectioneries such as chewing pastes, caramels and tablets, and the desired degrees of enlargement are between 24% and 40%.

According to another preferential mode of the present invention, the cores to be coated are constituted of dried fruits, and the desired degrees of enlargement are between 50% and 85% and preferably between 60% and 75%.

One variant of the process according to the invention consists in adding (typically by dusting), after applying the coating syrup, a polyol powder of high purity, preferably of greater than 95% by weight.

Thus, according to one embodiment, the present invention relates to a coating process as described above, characterized in that it also comprises one or more cycles each comprising the following steps:
(a) a step of applying a coating syrup containing at least one polyol, the polyol being obtained by hydrogenation of disaccharides, the said coating syrup having a solids content of between 60% and 90% by weight and preferably between 70% and 85% by weight;
(a-1) a step of applying a powder containing at least one polyol with a purity of greater than 95%;
(b) a drying step comprising the use of air at a temperature of between 40° C. and 70° C., for a time of at least 1 minute and of not more than 5 minutes.

According to one preferential mode, the said powder has a purity of greater than 98% and preferably greater than 99%. According to one embodiment, the polyol of step (a-1) is chosen from the group constituted by maltitol, hydrogenated maltulose, hydrogenated isomaltulose, lactitol, α-D-glucopyranosyl-1-6-sorbitol (=1,6-GPS), α-D-glucopyranosyl-1-1-mannitol (=1,1-GPM) and α-D-glucopyranosyl-1-1-sorbitol (=1,1-GPS), and mixtures thereof.

According to one particular mode of the invention, the polyol powder of step (a-1) contains a mixture of 1,1-GPM and GPS (1,6-GPS and 1,1-GPS).

As regards the polyol powder of step (a-1), it is preferable to use fine powders containing less than 60% of particles with a diameter of greater than 250 microns.

According to one particular embodiment of the process, the coating syrups applied may be prepared from the applied polyol powder of step (a-1) that is suitable for use in the process according to the invention.

According to another particular embodiment of the process, the said polyol powder and the said coating syrup have a polyol “in common”, i.e. the said powder and the said syrup contain a polyol ingredient in common.

According to this variant of the process combining the use of a syrup and a powder, degrees of enlargement of more than 30% are obtained in less than 2 hours and preferably in less than 1 hour 30 minutes, i.e. two to three times shorter than in the processes of the prior art.

According to one embodiment, the coating syrup of step (a) and/or the polyol powder of step (a-1) contain maltitol.

One of the objects of the process of the present invention is to considerably reduce the coating times.

According to one particular embodiment of the invention, additives such as colorants, intense sweeteners or flavourings may be added to the polyol syrup to be sprayed.

It is also possible to envisage incorporating binders such as plant gums, carboxymethylcellulose and gelatin, modified starchy foods and starches (from pea, corn, wheat, potato, tapioca, rice, etc.), maltodextrins, dextrins such as Nutriose®, resistant maltodextrins such as Fibersol®, polydextrose, maltitol syrups such as Lycasin® HBC, and fatty substances such as mono- and diglycerides.

Another particular embodiment of the invention may envisage mixing different polyols in the coating syrup and/or in the bulking agent.

According to one particularly advantageous embodiment of the invention, the coating syrup may also contain pigments such as calcium carbonate, titanium dioxide or a food colorant, and also intense sweeteners such as aspartame, acesulfame K, saccharin, sucralose, alitame, neotame, neohesperidin, thaumanin, sodium or calcium cyclamate, brazzein derivatives and steviosides.

Another variant of the invention consists in producing a multilayer coating, using several different polyols.

Another variant of the invention consists in adding to the coating syrups or to the polyol powder bulking agents such as talc, calcium carbonate, aluminium or magnesium silicates, Ca, Mg Na, Zn, Fe, P, Li salts, etc.

According to the invention, the products to be coated are subjected to turbining, i.e. to rotational motion in a coating pan. This coating pan may have a conventional shape, i.e. a tulip shape with an inclined axis of revolution, or alternatively a cylindrical shape with a horizontal axis. The cores have a spherical, cylindrical or oval shape in order to facilitate the coating operation, but may also have a cushion or lozenge shape. These conventional cores, which are sugar-less or sugar-free, may contain a liquid, pasty or pulverulent filling.

It should be noted that the cores or products to be coated may optionally undergo a gumming step that consists in binding onto the core a layer of adhesive substances that will allow better binding of the coating layers during the enlargement or coating step. Needless to say, after the enlargement process, it is possible to perform a glazing or waxing step in order to protect the coating from moisture and to give it a beautiful glossy appearance, by using, for example, fatty substances, lacquers or waxes.

The cores may also undergo a film-coating step, for example with modified pea starch sold by the Applicant under the brand name Lycoat® and pigments such as those sold by the company Merck under the brand name Candurin®.

The process in accordance with the invention enables the coating of products of all types such as, especially, food products such as confectioneries, chewing gums, bubble gums, tablets, lozenges, gelled articles, chewing pastes, hard-boiled candies, chocolate products, dried fruits such as almonds, hazelnuts or peanuts, pharmaceutical or veterinary products such as pills, tablets, products for animals, dietetic products such as plant granules, seeds or grains, agglomerated fertilizer powders, additives based on enzymes or microorganisms such as yeasts, detergent tablets, vitamins, flavourings, fragrances, acids, sweeteners or various active principles.

The implementation of the invention as described above makes it possible to obtain coated products of very high quality in considerably reduced coating times, which are shorter than those of the processes described in the prior art.

Thus, the present invention relates to a chewing gum coated with a hard crystalline layer obtained by implementing the process described above. More generally, the present invention thus relates to a coated product obtained by implementing the process described above, especially in which the core is chosen from the group constituted of chewing gums, bubble gums, lozenges, pellets, tablets, hard boiled candies, gums, chewing pastes, caramel, chocolate, dried fruits, dried vegetables, grains and active principles.

The invention will be understood more clearly with the aid of the examples that follow, which are intended to be illustrative but non-limiting.

### Example 1

### Hard Coating with Maltitol (Mint Flavour)

Equipment used: Driacoater 1200 sugar-coating machine containing 50 kg of chewing gum pads

### 1. Composition of the Coating Syrup:

(76% solids—90° C.)

| | Ingredients | Composition based |
|---|---|---|
| | by weight | on solids |
| Maltitol SweetPearl ™ P200 | 25.000 kg | 95.0% |
| Titanium dioxide | 0.263 kg | 1.0% |
| Gum arabic (40% solids) | 1.980 kg | 3.0% |
| Sorbitol Neosorb ® 70/02 | 0.373 kg | 1.0% |
| Water | 7.015 kg | |
| | | 100.00 |

The Neosorb® 70/02 is added to the coating syrup to improve the resistance to chipping as described in European patent EP 1 399 032, of which the Applicant is the proprietor.

### 2. Coating Parameters and Sequence (50 kg of Chewing Gums)

Phase 1=dust removal and preheating

| | Phase | | | | | | | | |
|---|---|---|---|---|---|---|---|---|---|
| | 2 | 3 | 4 | 5 | 6 | 7 | 8 | 9 | 10 |
| Number of cycles | 3 | 2 | 5 | 2 | 5 | 2 | 3 | 3 | 1 |
| Amount of syrup per | 0.8 | 1.0 | 1.2 | 1.0 | 1.4 | 1.0 | 1.4 | 0.8 | wax |
| cycle (kg) | | | | | | | | | |
| Standing time (min) | 0.5 | 0.5 | 0.5 | 1.0 | 0.5 | 1.0 | 0.5 | 3.0 | |
| Bulking agent (kg) | 0.50 | 0.50 | 0.50 | 0 | 0.40 | 0 | 0.25 | 0 | 0 |
| SweetPearl ™ P35 | | | | | | | | | |
| Standing time (min) | 0.5 | 0.5 | 0 | 0 | 0.5 | 0 | 1.5 | 0 | 5 |
| Drying time (min) | 3.0 | 3.0 | 3.0 | 3.0 | 3.0 | 2.0 | 1.5 | 1.0 | 5 |
| Drying air temperature | 28 | 36 | 42 | 50 | 50 | 50 | 50 | 26 | 26 |
| (° C.) | | | | | | | | | |
| Air flow rate/m³/ | 15 | 15 | 15 | 15 | 15 | 15 | 15 | 15 | 15 |
| min | | | | | | | | | |
| Spin speed (rpm) | 10 | 10 | 10 | 10 | 10 | 10 | 10 | 10 | 10 |

Mint flavouring was added to the surface of the cores during phases 5 and 7.

The total coating time is 120 minutes for a degree of enlargement of 37.5%.

The dew point of the drying air is −11° C.

The same degree of enlargement was obtained according to a “standard” coating process, such as those described in the prior art cited hereinabove, in 210 minutes.

The value of the present invention is demonstrated by the present example.

### Example 2

### Hard Coating with Maltitol (Mint Flavour)

Equipment used: Driacoater 1200 sugar-coating machine containing 50 kg of sugar-free chewing gums

### 1. Composition of the Coating Syrup:

(74% solids—90° C.)

| | Ingredients | Composition based |
|---|---|---|
| | by weight | on solids |
| Maltitol SweetPearl ™ P200 | 34.780 kg | 94.0% |
| Titanium dioxide | 0.370 kg | 1.0% |
| Gum arabic solution (40% solids) | 4.625 kg | 5.0% |
| Water | 10.225 kg | |
| | | 100.00 |

### 2. Coating Parameters and Sequence (50 kg of Chewing Gums)

Phase 1=dust removal and preheating

| | Phase | | | | | | | | | |
|---|---|---|---|---|---|---|---|---|---|---|
| | 2 | 3 | 4 | 5 | 6 | 7 | 8 | 9 | 10 | 11 |
| Number of cycles | 3 | 2 | 3 | 3 | 2 | 4 | 2 | 4 | 2 | wax |
| Amount of syrup per | 0.7 | 0.9 | 1.2 | 1.4 | 1.2 | 1.4 | 1.2 | 0.8 | 0.4 | wax |
| cycle (kg) | | | | | | | | | | |
| Standing time (min) | 0.5 | 0.5 | 0.5 | 0.5 | 1 | 0.5 | 1 | 3.5 | 3 | 5 |
| Bulking agent (kg) | 0.45 | 0.45 | 0.45 | 0.45 | 0 | 0.35 | 0 | 0 | 0 | 0 |
| SweetPearl ™ P35 | | | | | | | | | | |
| Standing time (min) | 1 | 1 | 1 | 1 | 0 | 1 | 0 | 0 | 0 | 0 |
| Drying time (min) | 3.0 | 3.0 | 2.5 | 2.5 | 2.5 | 2.5 | 2.5 | 1.0 | 0 | 5.0 |
| Drying air | 32 | 38 | 45 | 45 | 45 | 45 | 40 | 32 | 26 | 26 |
| temperature (° C.) | | | | | | | | | | |
| Air flow rate/m³/ | 15 | 15 | 15 | 15 | 15 | 15 | 15 | 15 | 15 | 15 |
| min | | | | | | | | | | |
| Spin speed (rpm) | 11 | 11 | 11 | 11 | 11 | 11 | 11 | 12 | 12 | 12 |

Mint flavouring was added to the surface of the cores during phases 6 and 8.

The total coating time is 120 minutes for a degree of enlargement of 36%.

The dew point of the drying air is −10° C.

The same degree of enlargement was obtained according to a “standard” coating process, such as those described in the prior art cited hereinabove, in 220 minutes.

The value of the present invention is demonstrated by the present example.

### Example 3

### Hard Coating with Maltitol (Mint Flavour)

Equipment used: Driacoater 1200 sugar-coating machine containing 50 kg of chewing gum pads

### 1. Composition of the Coating Syrup:

(80% solids—90° C.)

| | Ingredients | Composition based |
|---|---|---|
| | by weight | on solids |
| Maltitol SweetPearl ™ P200 | 25.000 kg | 89.0% |
| Titanium dioxide | 0.280 kg | 1.0% |
| Lycasin ® HBC (73% solids) | 3.830 kg | 10.0% |
| Water | 6.000 kg | |
| | | 100.00 |

### 2. Coating Parameters and Sequence (50 kg of Chewing Gums)

Phase 1=dust removal and preheating

| | Phase | | | | | | | |
|---|---|---|---|---|---|---|---|---|
| | 2 | 3 | 4 | 5 | 6 | 7 | 8 | 9 |
| Number of cycles | 2 | 3 | 5 | 2 | 5 | 2 | 4 | 1 |
| Amount of syrup per | 0.8 | 1.2 | 1.4 | 1.4 | 1.6 | 1.2 | 0.8 | wax |
| cycle (kg) | | | | | | | | |
| Standing time (min) | 0.5 | 0.5 | 0.5 | 1.5 | 0.5 | 2.0 | 5.0 | |
| Bulking agent (kg) | 0.50 | 0.50 | 0.50 | 0 | 0.40 | 0 | 0 | 0 |
| Pearl ™ P35 | | | | | | | | |
| Standing time (min) | 0.5 | 0.5 | 1.0 | 0 | 1.5 | 0 | 0 | 5 |
| Drying time (min) | 3.0 | 3.0 | 2.5 | 2.0 | 1.5 | 1.5 | 0 | 10 |
| Drying air temperature (° C.) | 32 | 38 | 45 | 50 | 50 | 50 | 35 | 26 |
| Air flow rate/m³/min | 15 | 15 | 15 | 15 | 15 | 15 | 15 | 15 |
| Spin speed (rpm) | 10 | 10 | 10 | 10 | 10 | 11 | 11 | 15 |

Mint flavouring was added to the surface of the cores during phases 5 and 7.

The total coating time is 105 minutes for a degree of enlargement of 37.4%.

The dew point of the drying air is −11° C.

The same degree of enlargement was obtained according to a “standard” coating process, such as those described in the prior art cited hereinabove, in 220 minutes.

The value of the present invention is demonstrated by the present example.

### Example 4

### Hard Coating with Maltitol (Mint Flavour)

Equipment used: Driacoater 1200 sugar-coating machine containing 50 kg of chewing gum pads

### 1. Composition of the Coating Syrup:

(76% solids—90° C.)

| | Ingredients | Composition based |
|---|---|---|
| | by weight | on solids |
| Maltitol Pearl ™ P200 | 25.000 kg | 94.0% |
| Titanium dioxide | 0.266 kg | 1.0% |
| Gum arabic (40% solids) | 3.320 kg | 5.0% |
| Water | 6.400 kg | |
| | | 100.00 |

### 2. Coating Parameters and Sequence (50 kg of Chewing Gums)

Phase 1=dust removal and preheating

| | Phase | | | | | | | | | |
|---|---|---|---|---|---|---|---|---|---|---|
| | 2 | 3 | 4 | 5 | 6 | 7 | 8 | 9 | 10 | 11 |
| Number of cycles | 3 | 3 | 4 | 2 | 4 | 2 | 2 | 2 | 2 | 1 |
| Amount of syrup | 0.9 | 1.2 | 1.5 | 1.3 | 1.5 | 1.3 | 1.2 | 0.8 | 0.4 | wax |
| per cycle (kg) | | | | | | | | | | |
| Standing time | 0.5 | 0.5 | 0.5 | 1.5 | 0.5 | 1.5 | 3.0 | 3.0 | 4.0 | |
| (min) | | | | | | | | | | |
| Bulking agent | 0.50 | 0.50 | 0.50 | 0 | 0.40 | 0 | 0 | 0 | 0 | 0 |
| (kg) Pearl ™ P35 | | | | | | | | | | |
| Standing time | 0.5 | 0.5 | 0.5 | 0 | 1.0 | 0 | 0 | 0 | 0 | 5 |
| (min) | | | | | | | | | | |
| Drying time | 3.0 | 2.5 | 2.0 | 2.0 | 2.0 | 2.0 | 1.0 | 1.0 | 0 | 5 |
| (min) | | | | | | | | | | |
| Drying air | 32 | 38 | 45 | 50 | 50 | 50 | 50 | 32 | 26 | 26 |
| temperature (° C.) | | | | | | | | | | |
| Air flow rate/ | 15 | 15 | 15 | 15 | 15 | 15 | 15 | 15 | 15 | 15 |
| m³/min | | | | | | | | | | |
| Spin speed (rpm) | 10 | 11 | 11 | 11 | 11 | 11 | 11 | 11 | 12 | 15 |

Mint flavouring was added to the surface of the cores during phases 5 and 7.

The total coating time is 107 minutes for a degree of enlargement of 35.4%.

The dew point of the drying air is −11° C.

The same degree of enlargement was obtained according to a “standard” coating process, such as those described in the prior art cited hereinabove, in 225 minutes.

The value of the present invention is demonstrated by the present example.

### Example 5

### Organoleptic Qualities of the Products Obtained

All the chewing gums obtained by performing Examples 1 to 4 cited above have entirely satisfactory organoleptic characteristics.

What is more, the final crunchiness appears 1 to 2 days after the end of the process, which presents a considerable advantage for the packaging of the said products. The reason for this is that when these products are packaged, they do not yet have their final crunchiness, and are thus less fragile and less subject to impacts and breakage.

The present invention thus has many advantages, and is also beneficial for solving the problems associated with breakage during the packaging step.

1. Process of sugar-free hard coating, allowing the creation of a hard coating at the surface of a core in less than two hours, and comprising a plurality of cycles each comprising the following steps:
(a) a step of applying a coating syrup containing at least one polyol, the said polyol being obtained by hydrogenation of disaccharides, and the said coating syrup having a solids content of between 60% and 90% by weight and preferably between 70% and 85% by weight;
(b) a drying step comprising the use of air with a temperature of between 40° C. and 70° C., for a time of at least 1 minute and of not more than 5 minutes;
the number of cycles being such that a degree of enlargement of greater than 25%, preferentially greater than 30% and more preferentially greater than 32% is obtained.

2. Coating process according to claim 1, wherein the polyol of step (a) is selected from the group consisting of maltitol, hydrogenated maltulose, hydrogenated isomaltulose, lactitol, α-D-glucopyranosyl-1-6-sorbitol (=1,6-GPS), α-D-glucopyranosyl-1-1-mannitol (=1,1-GPM) and α-D-glucopyranosyl-1-1-sorbitol (=1,1-GPS), and mixtures thereof.

3. Coating process according to claim 1, wherein the solids content of the said coating syrup is between 60% and 90%, more preferably between 70% and 85% and even more preferentially greater than or equal to 76% and less than 80% by weight.

4. Coating process according to claim 1, wherein step (b) comprises the use of air at a temperature of between 45° C. and 60° C. and preferably between 47 and 53° C.

5. Coating process according to claim 1, wherein the set of drying steps comprises the use of air at least 45° C. and at not more than 55° C., for a cumulative time of at least 10 minutes and preferably of at least 15 minutes.

6. Coating process according to claim 1, wherein the abovementioned degree of enlargement of greater than 25% is obtained in less than 1 hour 30 minutes.

7. Coating process according claim 1, wherein the polyol of step (a) is maltitol.

8. Coating process according to claim 1, wherein it also comprises one or more cycles each comprising the following steps:
(a) a step of applying a coating syrup containing at least one polyol, the polyol being obtained by hydrogenation of disaccharides, the said coating syrup having a solids content of between 60% and 90% by weight and preferably between 70% and 85% by weight;
(a-1) a step of applying a powder containing at least one polyol with a purity of greater than 95%;
(b) a drying step comprising the use of air at a temperature of between 40° C. and 70° C., for a time of at least 1 minute and of not more than 5 minutes.

9. Coating process according to claim 8, wherein the polyol of step (a-1) is chosen from the group constituted by maltitol, hydrogenated maltulose, hydrogenated isomaltulose, lactitol, α-D-glucopyranosyl-1-6-sorbitol (=1,6-GPS), α-D-glucopyranosyl-1-1-mannitol (=1,1-GPM) and α-D-glucopyranosyl-1-1-sorbitol (=1,1-GPS), and mixtures thereof.

10. Process according to claim 8, wherein the purity of the said powder of step (a-1) is greater than 98% and preferably greater than 99%.

11. Process according to claim 8, wherein the syrup of step (a) and/or the powder of step (a-1) contain maltitol.

12. Coating process according to claim 1, wherein the core to be coated is a food product, especially a chewing gum, a veterinary, pharmaceutical or dietetic product, a seed or a grain, a fertilizer powder, or alternatively an additive based on enzymes, microorganisms, vitamins, flavourings, fragrances, acids, sweeteners or active principles.
